(19) United States
(12) Patent Application Publication
(10) Pub. No.: US 2024/0362484 A1
(43) Pub. Date: Oct. 31, 2024

(54) Network Learning Apparatus and Methods

(71) Applicant: Navier, Inc., Chicago, IL (US)

(72) Inventor: Daniel Marks, Durham, NC (US)

(21) Appl. No.: 18/765,486

(22) Filed: Jul. 8, 2024

Related U.S. Application Data
(60) Provisional application No. 63/525,645, filed on Jul. 7, 2023.
(60) Provisional application No. 63/398,301, filed on Aug. 16, 2022.

(51) Int. Cl. G06N 3/08

(52) U.S. Cl. CPC G06N 3/08

(57) ABSTRACT

A network learning machine and methods including worker computers that receive instruction communications from assignment computers and an analysis computer that produces training data and creates a network machine learning model that includes at least one parameter and a criterion for optimality, and adjusts the at least one parameter of the machine learning model toward the criterion to optimality based on the training data.

### I. INCORPORATION BY REFERENCE

The present patent application incorporates by reference U.S. Provisional Patent Application No. 63/525,645, Titled: “Network Learning Apparatus and Methods”, filed Jul. 7, 2023, in its entirety as if fully restated herein. U.S. Provisional Patent Application No. 63/525,645 incorporates by reference U.S. Provisional Patent Application No. 63/398,301, Titled: “Dynamically Configurable Network Architecture and Methods”, filed Aug. 16, 2022, in its entirety as if fully restated herein.

### II. BACKGROUND

Various and diverse approaches have been considered for machine learning. Compare US20230169595A1—a system for varying the chip voltage of a cryptocurrency miner based on the estimated profitability of the miner; US20220300394A1 which involves data flow to sleeping computer systems based on economic feasibility; and U.S. Pat. No. 11,055,676B2—in which artificial intelligence switches a wireless access point from an “access point mode” to a “mining mode” based on the artificial intelligence of a stratum mining server.

Other approaches include U.S. Pat. No. 11,410,207B2, which concerns using AI and blockchain data to execute trades of cryptocurrency with a smart contract, KR102112126B1, which concerns determining cryptocurrency transactions using artificial intelligence; JP2021551557A5, which concerns creating a smart contract to “sense” on the blockchain network whether something is within a particular range and execute. Note too KR20210122941A, which concerns analyzing cryptocurrency account transactions to determine the “intrinsic value” of cryptocurrency using artificial intelligence; US20230185996A1, which involves doing a simulation of a transaction on a blockchain to determine a “stress level” that indicates whether a transaction is secure or not, US20230177507A1, which involves predicting whether a user will complete a cryptocurrency exchange operation so that the exchange rate is locked in, and AU2022235554A1, which involves directing “stored energy” to cryptocurrency miners.

Yet network structures, a need has been observed herein for artificial intelligence and machine learning as regards computer network learning and aspects thereof.

### III. SUMMARY

This Summary is provided to introduce the idea herein that a selection of concepts is presented in a simplified form as further described below. This Summary and the following Overview are not intended to identify key features or essential features of subject matter, nor are the Summary and Overview intended to be used to limit the scope of claimed subject matter. Nothing herein is intended to serve as an admission of prior art, as the comments are present and informal understandings. Additional aspects, features, and/or advantages of examples will be indicated in part in the description which follows and, in part, will be apparent from the description, or may be learned by practice of the disclosure.

The following description of modes, the drawings, and the Summary are illustrative and are not to be construed as limiting. Numerous specific details are described to provide a thorough understanding of the disclosure. However, in certain instances, well-known or conventional details are not described to avoid obscuring the description. References to one or an embodiment in the disclosure can be, but not necessarily are, references to the same embodiment; and such references mean at least one of the embodiments.

Reference in this specification to “one embodiment” or “an embodiment” means that a feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider apparatuses and articles of manufacture, processes for using the apparatuses and articles, processes for making the apparatuses and articles, and products produced by the processes of making, along with necessary intermediates, in the context that some, but not all, embodiments concern, in whole or part, relating to a network learning apparatus and methods, such as in connection with adjusting at least one parameter of a machine learning model toward a criterion to optimality based on training data.

In that context, consider that a computer network, that may but need not be a pool, can examine communications, in some but not all applications, for a hash. Any result from the examination can be reported to a computer that may, but need not always be, one or more assignment computers. Another computer, such as an analysis computer, creates training data based or at least partially based on such as instructions. So, in this but not all examples, the instructions can be instructions to do work, received by worker computers from the assignment computers, and the submissions of the results of the work to the assignment computers from the worker computers. The learning model, determined by the analysis computer, includes one or more parameters. The model also includes an optimality criterion that is based in part on a trial value of the parameter(s)—that is, particular values of the parameter(s), not necessarily the optimal one(s), and the training data. The optimality criterion is usually, but not always, a number which is either maximized or minimized, with the analysis computer varying the parameter(s) to find a set of values of the parameter(s) that maximizes or minimizes the optimality criterion number. The result need not be the best possible, but only an improvement on the optimality criterion over a previous value or values of the parameter(s). The analysis computer searches for values of the parameter(s) that, given the training data and the optimality criterion, improves the optimality criterion. In some cases, the analysis computer then produces an improved model with one or more parameters that include the training data as input so as to optimize the criterion.

### IV. INDUSTRIAL APPLICABILITY

Industrial applicability is representatively directed to that of apparatuses and devices, articles of manufacture, and processes of making and using them as disclosed herein. Industrial applicability also includes industries engaged in such as one or more of computer science and electrical engineering, field programmable gate arrays, application specific integrated circuits, cryptography, cryptocurrency mining, central processing units, simulations, memory such as random access memory, nonvolatile memory, and rotating media storage or solid state flash memory storage, networking, communications and/or telecommunications, and computing systems, e.g., those involving networking and networking architecture, with or without a director computer, e.g., as in layers, as well as industries operating in cooperation therewith, depending on the implementation.

### V. FIGURES

FIG. 1 is an illustration of an embodiment of flow of a network architecture.

FIG. 2 is an illustration of an embodiment of flow of the network architecture.

FIG. 3 is an illustration of an embodiment of an instruction.

FIG. 4 is an illustration of an embodiment of flow of a network architecture.

FIG. 5 is an illustration of an embodiment of flow of the network architecture.

FIG. 6 is an illustration of an embodiment of an instruction.

### VI. MODES

A network of computers can be organized to search for a solution to a particular computational problem. There is a set of possible solutions, each possible solution being an element of the set, and a computer of the network can test an element of the set to determine if the element is a solution to the problem. Seeking the solution to particular computational problems may require testing a vast number of possible solutions, thereby requiring a great computational effort. To minimize the amount of effort required to find a solution, and to maximize the number of solutions found given limited computational resources, in some but not all cases, it is desirable to find strategies that can identify the most promising potential solutions and direct the computational effort to testing those solutions first.

Such networks can be organized such that there are assignment computers and worker computers. A worker computer can test potential solutions and may receive instructions from an assignment computer as to which solutions the worker computer should test. A group of assignment computers may coordinate as to distribute elements of the set of solutions amongst the worker computers, so that a worker may not determine the work that the worker receives. This may be disadvantageous to the worker, as information may be available to help determine which solutions are the most promising and therefore should be attempted first by the worker.

While the number of potential solutions to many difficult search problems is enormous, for some problems machine learning methods can be used to identify patterns and trends that can be used to identify subsets of the possible solutions more likely to contain an actual solution. A learning model may be created from various data sources available to worker computers to attempt to identify more promising solutions. The availability of such a model could be used to guide a worker computer as to what kind of instructions a worker computer should request, what instructions the worker computer should accept, which assignment computers the worker computer should accept work from, and the networks the worker computer should obtain work from, for example. In doing so, the probability of a worker computer identifying a solution may be improved.

Finding a solution with the minimum computational effort or in the minimum time may be quite important for some problems. For example, one may only be able to purchase a limited amount of computing resources on a cloud computing network and wish to obtain the best possible solution given the resources. For example, optimization of integrated circuit logic, circuit path routing, training, and pruning neural networks, determining the conformation of polymers and proteins, and testing cryptographic keys and cryptocurrency mining are such problems. For some problems, such as in financial modeling and cryptocurrency mining, the financial benefit or reward obtained from the solution may directly depend on how quickly the solution is found. Therefore, there may be significant incentives to rapidly identify solutions before others who are trying to solve the same problems.

Examples of networks are provided herein to illustrate the principles of the disclosed embodiments. There is a computational problem to be solved with a large number of solutions to be tested. The solution to the problem is defined by a condition which determines the degree to which a possible solution satisfies the problem. For example, the problem may be finding the routes of thousands of vehicles to deliver packages. Each potential solution, or element of the set of solutions, consists of a specification of a route for each vehicle, and the set of possible solutions consists of all possible ways to assign routes jointly to all of the vehicles. Alternatively, the computational problem may be finding the conformation of a protein that minimizes the energy of the conformation. Each potential solution of the set is a possible conformation, and the set of possible solutions may consist of all possible conformations of the protein.

Alternatively, the computational problem may be finding a number which when a cryptographic hash function is applied to it, has a particular value. The potential solutions may be all of the numbers that may be accepted by the cryptographic hash function. A group of assignment computers may partition subsets of the set of possible solutions between them. A worker computer may contact an assignment computer over an assignment computer connection to obtain instructions as to what elements of the set of solutions the worker computer should test. The assignment computer may then send an instruction to the worker computer that assigns a subset of the solutions that is already partitioned to the assignment computer. The worker computer then tests the elements given in the instruction that the worker computer received with the condition which identifies a solution. If the worker computer identifies one or more of the elements as a solution, the worker computer may send a response to the assignment computer identifying the element or elements of the set of solutions that satisfies the condition. If the worker computer does not identify a solution, the worker computer may send a response that no elements were identified as satisfying the condition to the assignment computer.

When the worker computer receives instructions from an assignment computer, the worker computer may receive instruction communications over the assignment computer connection. Similarly, the worker computer may return response communications over the assignment computer connection. The instruction communications and response communications may be monitored and recorded to capture data that may be useful for building a learning model used to infer which subsets of the solutions that may be more promising to search for a solution to the problem. If a large amount of instruction communications and response communications is captured from a large number of worker computers connected to a large number of assignment computers, trends might be identified that could be exploited to more rapidly find solutions to the problem.

The instruction communications can include a specification of the elements or possible solutions that a worker computer should test to see if any of the elements of the set satisfy the desired condition. By monitoring the instruction communications received by worker computers from a first set of assignment computers, one may be able to obtain information about the portion of the set of the possible solutions that this first set of assignment computers assigned to worker computers. Based on this information, one may be able to predict or anticipate subsequent instructions and the portions of the set of possible solutions that will be assigned by this first set of assignment computers to worker computers. Worker computers may then be instructed or commanded, perhaps by a second set of assignment computers, to test the portions of the set of possible solutions that are anticipated to be assigned in the future by this first set of assignment computers before these are actually assigned. The worker computers may then find a solution that satisfies the condition before the worker computer otherwise would have had the worker computers waited for an instruction to test the elements of the set from the first set of assignment computers.

Similarly, the response communications returned to a first set of assignment computers from worker computers may also be monitored to obtain information about portions of the set of possible solutions that may be more likely to contain an element of the set that satisfies the desired condition. For example, the delay between when a worker receives an instruction communication and a worker replies with a response communication may be indicative of the degree to which the possible solutions tested by the worker satisfy the condition. Possible solutions that satisfy the condition to a higher degree may take more time for a worker computer to test than solutions that satisfy the condition to a lower degree, and by observing the amount of time for the worker computer to test a solution, one might gather information about the set of possible solutions that better satisfy the condition. One may then be able to use this information to predict or anticipate which further solutions may be tested that might satisfy the condition to an even higher degree. Worker computers may then be instructed or commanded, perhaps by a second set of assignment computers, to test the portions of the set of possible solutions that are anticipated to better satisfy the condition than the already observed tested solutions.

Machine learning models may be used to predict or anticipate possible solutions to problems. A typical machine learning model may be an artificial neural network consisting of a directed graph of nodes connected together by edges which indicate the transmission of information through the model. Each edge may contain a parameter or weight, and the sample or signal at a node may then be the accumulated sum of all of the samples or signals from the other nodes with edges directed toward the node, with the signal from each of the other nodes multiplied by the parameter of weight of the edge.

A nonlinear operation such as a hard or soft thresholding operation may be applied at each node as an activation function. Data is input into the machine learning model as the sample or signal magnitude at input nodes, and the output, or result of the inferences, of the machine learning model is taken at output nodes. The magnitude of the sample or signal at each of the output nodes may indicate the degree to which a particular hypothesis is supported by the data input to the input nodes. For example, the magnitude of input data may be samples that indicate the identity of one or more possible solutions to problems being assigned to worker computers, and the magnitude of output nodes might indicate the degree to which a given element or subset of the possible solutions to the problem may satisfy the condition.

A machine learning model may be trained by preparing training data and then training the model with the training data. This training data may include the identity of possible solutions and the degree to which it is estimated that each solution satisfies the condition. Furthermore, a machine learning model may have a criterion for optimality. The criterion for optimality describes how accurately the inference of the machine learning model matches an input to the machine learning model to its corresponding hypothesis. A machine learning model that has been trained such that the inferences of the machine learning model for each input item of the training data more closely matches the corresponding inferences in the training data better satisfies the criterion for optimality. The training process adjusts the parameters or weights of the machine learning model so that the inferences of the model better satisfy the criterion for optimality. The criterion for optimality can be a mathematical function that, given an item or items of the training data, a particular set of parameters or weights characterizing the machine learning model, and the corresponding output for each item of training data, is minimized when the inferences of the machine learning model best match the desired outputs given in the training data. Training the machine learning model then may be a process of repeatedly adjusting the parameters of the machine learning model, calculating the criterion for optimality, and then determining if the criterion for optimality is lower for the tested set of parameters than previously tested sets of parameters, and keeping the set of parameters that best fits the criterion for optimality. There are numerous approaches to optimize the process of training a machine learning model, including backpropagation, genetic programming, linear programming, among others.

Once training data has been obtained, for example by examining instruction communications and response communications, determining the sets of solutions tested in the instructions of the instruction communications and responses of the response communications, and creating an estimate to the degree the solutions satisfy the condition, a machine learning model may be created and trained with this training data. One then may inputs to the machine learning model that were not included in the training data set and observe hypotheses output by the machine learning model. If a hypothesis output by the machine learning model indicates that a given solution or set of solutions is more likely to satisfy the condition, that may be used to instruct or command worker computers to test those solutions. The machine learning model may be further trained with additional training data, perhaps improving the accuracy of its hypotheses and therefore be better at directing worker computers to find a solution that satisfies the condition.

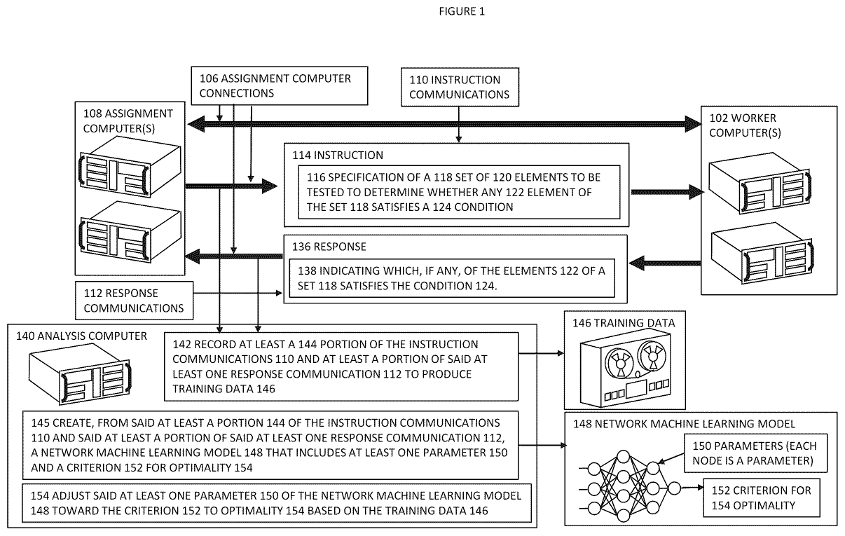

The embodiments herein illustrate implementations of strategies to create machine learning models to identify more promising solutions or trends that may be used to direct the effort of a worker computers on a network with a group of assignment computers. With reference to FIG. 1, a group of assignment computers 108 is configured to send instruction communications 110 over one or more assignment computer connections 106 to two or more worker computers 102, and receive response communications 136 over the assignment computer connections 106 from the worker computers 102. The instruction communications 110 include one or more instructions 114.

An instruction 114 can instruct a worker computer 102 to perform work, which may include searching for a solution to a problem that satisfies a condition 124. The possible solutions to the problem constitute a set 118 of possible solutions, with the possible solutions being the elements 120 of the set 118, and each possible solution being an element 122 of the set. The work a worker computer 102 performs may including testing to determine if one or more elements 120 of the set 118 is a solution to the problem, a solution being an element that satisfies the condition 124. The instruction 114 then may include a specification 116 of the set 118 of elements 120 to be tested by the worker computer to determine whether any element 122 of the set 118 satisfies the condition 124. The worker computer 102 may test the elements 120 specified in the specification 116 in response to receiving the instruction 114 and determine if any of the elements 120 of the set 118 satisfies the condition 124.

The worker computer 102 may then send a response 136 included in the response communications 112 to the assignment computer connection 106 from which the instruction 114 was received. If one or more of the elements 122 tested by the worker computer satisfies the condition 124, the response 136 may include an indication of which elements 122 of the set 118 satisfies the condition 124. If none of the elements 122 tested by the worker computer 102 satisfies the condition 124, the response 136 may indicate that no elements 122 were identified that satisfy the condition 124, or the worker computer 102 may send no response 136 to the instruction 114.

The assignment computers 108 may be commodity computer hardware, for example based on processors from Intel, AMD, ARM-based, RISC-V based, etc. These are typically equipped with random access memory such as DRAM, nonvolatile storage such as rotating magnetic media or NAND flash storage, and one or more network connections such as Ethernet, wireless networks such as WiFi and mobile telephone networks, to a local area network (LAN), to a wide area network (WAN), etc. The assignment computers 108 may communicate with each other to determine in part which specifications 116 of the set 118 of elements 120 each should include in instructions 114, in particular to ensure that the same elements 120 are not redundantly assigned to multiple worker computers 102, perhaps unless it is desired to have redundancy to increase reliability. An assignment computer 108 may include an operating system such as Windows, Linux, MacOSX, a variant of BSD, etc. An assignment computer 108 may include a computer program to implement the task of sending instructions 114 and receiving responses 136, with the computer programs to implement the task written in a computer language such as C, C++, Python, Java, Rust, Golang, etc.

The worker computers 102 may be commodity computer hardware, for example based on processors from Intel, AMD, ARM-based, RISC-V based, etc. These are typically equipped with random access memory such as DRAM, nonvolatile storage such as rotating magnetic media or NAND flash storage, and one or more network connections such as Ethernet, wireless networks such as WiFi and mobile telephone networks, to a local area network (LAN), to a wide area network (WAN), etc. The worker computers 102 may further be equipped with hardware that is specialized for testing to determine whether an element 122 of the set 118 satisfies a condition 124. This hardware may include field programmable gate arrays (FPGAs), application specific integrated circuits (ASICs), general purpose graphics processing units (GPGPUs), tensor processing units (TPUs), and hardware to calculate cryptographic functions such as cryptographic hash functions including SHA-256. The hardware may allow a worker computer 102 to test elements 122 of the set 118 more rapidly and therefore send a response 136 sooner than a worker computer 102 without the specialized hardware. A worker computer 102 may include an operating system such as Windows, Linux, MacOSX, a variant of BSD, etc. A worker computer 102 may include a computer program to implement the task of receiving instructions 114 and replying with responses 136, with the program testing whether elements 120 of a set 118 satisfy a condition 124 based on a specification 116 included in an instruction 114, perhaps using specialized hardware in part to perform the testing. The program to implement the task may be written in a computer language such as C, C++, Python, Java, Rust, Golang, etc.

An instruction 114 may include instructing a worker computer 102 to search for a solution to a problem that satisfies a condition 124. This problem is typically one such that the possible solutions form a set 118 of solutions, and the worker computers 102 search for the solution to the problem by testing elements 120 of the set 118 to determine whether any element 122 of the set 118 satisfies a condition 124. Such problems are frequently problems such that there a large number of possible solutions to be tested, and the possible solutions can be tested independently by a large number of worker computers. A condition 124 may be used to compare to possible solutions to determine which of the solutions is superior or has more desirable qualities. The condition 124 may be defined by a measure or metric, with the measure or metric of a better solution (or element 122 of the set 118) being greater or less than the measure or metric of a worse solution (or other element 112 of the set 118). The condition 124 may be whether or not a particular solution (or element 122 of the set 118) has a measure or metric exceeding a particular desired value, for example, the measure or metric of the best currently known solution to the problem. The condition 124 may be defined as a binary condition as to whether a possible solution (or element 122 of the set 118) does or does not have a certain property or quality.

Such problems include:
1. Determining the delivery routes of many vehicles simultaneously as to visit each address in an area. A possible solution to the problem, or element 120 of the set 118, is a possible combination of routes for all of the vehicles. A worker computer 102 may then evaluate one or more of the possible combinations of routes (or elements 120 of the set 118) and determine if any of these possible combinations of routes is an element 122 that satisfies the condition 124. The condition 124 may be to find the combination of routes with the total shortest path length less than a certain target path length.
2. Determining the conformation of a protein with the minimum energy. Each possible conformation of a protein may be considered as part of a set 118 of elements 120 of possible solutions to the problem of the conformation of the protein with the minimum energy. A simulation of the protein conformation may yield an estimate as to the energy of the conformation. A condition 124 may be to find a conformation that has an energy below a certain target value, or may be to find a conformation with a minimized value. A worker computer 102 may then perform simulations of protein conformations to determine if any of the simulated conformations satisfies the condition 124.
3. Determining the initial configuration of bodies in an N-body dynamics simulation that achieves a particular final configuration. The possible solutions for the initial configurations of bodies N-body dynamics simulation may be considered as part of a set 118 of elements 120, with each possible solution being an initial configuration of the N bodies. A simulation of the dynamics of the N-bodies may yield an estimate of the final configuration. A condition 124 may be a metric or measure of how closely the final configuration conforms to the desired final configuration.
4. Determining the cryptographic key that decrypts a particular message. Each possible cryptographic keys that may decrypt the message may be considered as an element 120 of a set 118 of possible solutions. A condition 124 may be such that the message decrypted with the correct cryptographic key contains a particular known prefix or text. The worker computers 102 may then decrypt the message with possible cryptographic keys and determine if the condition 124 is satisfied for one or more of the keys.
5. Determining a number that, after a cryptographic hash function is applied to the number, has a certain property. The property may be, for example, the number output from the cryptographic hash function is less than a certain specified value. Each possible number input to the cryptographic hash function may be considered as an element 120 of a set 118 of possible solutions. A condition 124 may be that the output of the cryptographic hash function satisfies a certain property such as being less than a certain target number. The worker computers 102 may then apply the cryptographic hash function to a numbers to determine if any of the outputs of the cryptographic hash function satisfy the condition 124.
   Other suitable problems should be apparent based on the teaching herein.

An analysis computer 140 may be configured to record 142 at least a portion 144 of the instruction communications 110 and at least a portion of said at least one response communication 112 to produce training data 146. The instruction communications 110 may contain an instruction 114, and the instruction 114 may contain a specification 116 of a set 118 of elements 120 to be tested to determine whether any element 122 of the set 118 satisfies a condition 124. A response communication 112 may be a response 136 indicating which, if any of the elements 122 of a set 118 satisfies the condition 124. A response communication 112 may be a response 136 indicating that none of the elements 122 of a set 118 satisfies the condition 124. The record 142 may also include other information about communications such as the length of a communication (for example the number of bytes or packets that constitutes a communication), the time and/or date a communication was sent and/or received, the delay between the time when an instruction 114 was sent by an assignment computer connection 106 and the corresponding response 136 was received by the assignment computer connection 106, the delay between the time when an instruction 114 was received by a worker computer 102 and the correspond response 136 was sent by the worker computer 102, the count of the number of communications of a particular type that are sent on an assignment computer connection 106 or a group of assignment computer connections 106, the count of the number of communications of a particular type that are received on an assignment computer connection 106 or a group of assignment computer connections 106, the count of the number of communications of a particular type that are sent by a worker computer 102 or by a group of worker computers 102, the count of the number of communications of a particular type that are received by a worker computer 102 or by a group of worker computers 102, a specification 116 of a set 118 of elements 120 to be tested to determine whether any element 122 of the set 118 satisfies a condition 124, the indication 138 in a response 136 of which, if any, of the elements 122 of a set 118 satisfies the condition 124, the presence of a condition 124, etc.

An analysis computer 140 may produce training data 146 from the record 142. An analysis computer may create 145, from said at least a portion 144 of the instruction communications 110 and said at least a portion of said at least one response communication 112, a network machine learning model 148 that includes at least one parameter 150 and a criterion 152 for optimality 154. The training data 146 may be used to train a network machine learning model 148. The training data 146 may be organized into a group of training items, each training item being an input to the network machine learning model 148 and the desired corresponding output of the network machine learning model 148 for the input. The data used to compose each training item may be drawn from any of the aforementioned information stored in the record 142, including by example, the time and/or date of a communication, contents of a communication, a specification 116, an indication 138 in a response 136, etc. The desired output of each training item indicates a particular ideal output state to be output from the network machine learning model 148 when the input from the training item is input into the network learning machine model 148. The desired output may be an intended prediction or classification desired to be produced by the network machine learning model 148 in response to an input to the network machine learning model 148. The desired output may be a prediction of whether or not an element 122 of a set 118 satisfies a condition 124, or a classification of one or more conditions 124 an element 122 of a set 118 may satisfy. A network machine learning model 148 trained to produce such an output may then be useful for predicting which elements 122 of the set 118 satisfies one or more conditions 124. This may be used to direct worker computers 102 to test elements 120 that may be more likely to satisfy the conditions 124.

The network machine learning model 148 may contain one or more parameters 150 that may be varied so that the network machine learning model 148 produces the desired output for the corresponding input of each training item. The network machine learning model 148 created by the analysis computer 140 may be an artificial neutral network, a feedforward neural network, a recurrent neural network, a deep learning neural network, etc. The computation of the network machine learning model 148 which produces an output for a given input may be organized into a directed graph, with nodes connected together by directed edges. The value at each node may be the sum of the values of the nodes with edges that are directed toward it, weighted by a parameter 150 assigned to each edge. Furthermore, the value at each node may have a thresholding function intended to be an activation-type function such as soft-thresholding, hard-thresholding, a rectified linear unit (ReLu), a logistic function, etc. The computation of the network machine learning model 148 may consist of successively calculating each node from the other nodes with edges directed to the node weighted by the parameter corresponding to each edge, applying the activation function until the output nodes are calculated.

A network machine learning model 148 may have a criterion 152 for optimality 154. A network machine learning model 148, for a given training item, may produce a desired output for a corresponding input. However, the network machine learning model 148 may not produce exactly the desired output for the corresponding input, and it may not be possible to train the network machine learning model 148 to produce exactly each desired output for each corresponding input for all of the training items in the training data 146. A criterion 152 for optimality 154 is a measure or metric of the difference between the actual outputs produced by a network machine learning model 148 given the corresponding inputs and the desired ideal outputs as defined in the training data 146. If the actual outputs produced by the network machine learning model 148 match the desired ideal outputs in the training data 146, the criterion 152 for optimality 154 is minimized, as it is usually defined as an error metric which is minimum when there is agreement between the actual outputs and the ideal outputs. The criterion 152 for optimality 154 is by convention optimized by minimizing its value when the network machine learning model 148 produces outputs that best match the ideal outputs, however, a criterion 152 for optimality 154 may also be formulated that is optimized by maximizing instead, or vice-versa, by multiplying the criterion 152 for optimality 154 by negative one.

The criterion 152 for optimality 154 is often a function that produces a number, score, or penalty based on the output of the network machine learning model 148 for each input of each training item and the ideal output of each training item. It may be, for example, the squared error penalty difference between the actual output and the ideal output, or another norm such as the L-norm, with L=2 corresponding to the squared error penalty, L=0 corresponding to a perfect sparsity parity, L=1 being a convex sparsity penalty, and L=infinity being the infinity or maximum norm. There may be nonnegative weights applied to the difference between the actual output and ideal output. For a criterion 152 that minimizes classification error, categorical cross-entropy may also be used. The parameters 150 of the network machine learning model 148 are varied as to minimize the criterion 152 for optimality 154 and achieve agreement between the actual output and the ideal output as defined by the criterion 152 for optimality 154.

The analysis computer 140 adjusts 156 at least one parameter 150 of the network machine learning model 148 toward the criterion 152 for optimality 154 based on the training data 146. The analysis computer 140 may vary one or more parameters 150 of the network machine learning model 148, for example the parameters associated with the edges of an artificial neural network. The analysis computer 140 may then calculate the criterion 152 for optimality 154 given the training data and the varied parameters 150. If the criterion 152 for optimality 154 is a lower value than a criterion 152 for optimality 154 calculated from another set of parameters 150, the changes in the parameters 150 due to the variation may be retained by the analysis computer 140 and further improved upon by attempting more variations of the parameters 150. By successively varying the parameters 150 and keeping changes in the parameters 150 that reduce the criterion 152 for optimality 154, the analysis computer 140 can steadily reduce the error between the actual output of the network machine learning model 148 and its ideal output, thus producing a network machine learning model 148 that better reproduces the training data 146 at its output.

Because the number of parameters 150 tends to be quite large, there are methods that have been devised to optimize the parameter 150 of a machine learning model with less computational effort. For example, backpropagation, automatic differentiation, gradient descent, and the conjugate gradient method may be used by the analysis computer 140 separately and together to determine variations of parameters 150 more likely to reduce the criterion 152 for optimality 154. The analysis computer 140 may also apply stochastic descent methods, which apply random variations to the parameters 150, to avoid stagnation in local minima of the criterion 152 for optimality 154. Furthermore, the analysis computer 140 may vary only subsets of the parameters 150, or add additional parameters 150 to the network machine learning model 148, while at the same time adding these parameters 150 to the criterion 152 for optimality 154, as to successively build more complex network machine learning models 148 that best fit the actual output to the ideal output. Other methods can be used for varying the parameters 150 and minimizing the criterion 150 for optimality 154 as may be preferred in one application or another.

An analysis computer 140 may be commodity computer hardware, for example based on processors from Intel, AMD, ARM-based, RISC-V based, etc. It is typically equipped with random access memory such as DRAM, nonvolatile storage such as rotating magnetic media or NAND flash storage, and one or more network connections such as Ethernet, wireless networks such as WiFi and mobile telephone networks, to a local area network (LAN), to a wide area network (WAN), etc. An analysis computer 140 may further be equipped with hardware that is specialized for creating a network machine learning model 148. This includes tensor processing units (TPUs), general purpose graphics processing units (GPGPUs), field programmable gate arrays (FPGAs), application specific integrated circuits (ASICs), among others. An analysis computer 102 may include an operating system such as Windows, Linux, MacOSX, a variant of BSD, etc. A director computer 102 may include a computer program to implement the task of recording 142 at least a portion 144 of the instruction communications 110 and at least a portion of said at least one response communication 112 to produce training data 146. This program may be a passive observation such as a packet sniffer, for example, Wireshark, or it may be actively receiving these communications relayed by assignment computers 108 and/or worker computers 102. A worker computer 102 may include a computer program to implement creating 145 and adjusting 156 the network machine learning model 148. This computer program may include one or more libraries to build and adjust such models such as Tensorflow, Keras, and Pytorch. These libraries may use specialized hardware such as tensor processing units to accelerate the training of a network machine learning model 148. These programs may be implemented in computer languages such as C, C++, Python, Java, Rust, Golang, etc.

An embodiment, such as might be described by FIG. 1, may be a network learning apparatus. The network learning apparatus may be configured, for example, by for example, configuring the worker computers 102, the assignment computer connections 106, the analysis computer 140, or a combination thereof. The configuration of the network learning apparatus may include, for example, configuring the worker computers 102, the assignment computer connections 106, the analysis computer 140, or a combination thereof, to be characterized by a certain property, for example by computational capacity. The configuration of the network learning apparatus may include, for example, configuring the worker computers 102, the assignment computer connections 106, the analysis computer 140, or a combination thereof, to include computer hardware, for example, tensor processing units, graphics processing units, field programmable gate arrays, or other computer hardware. The configuration of the network learning apparatus may include, for example, configuring the worker computers 102, the assignment computer connections 106, the analysis computer 140, or a combination thereof to communicate with a particular protocol, for example the Stratum mining protocol, or to configure particular computers to communicate on a network of the network learning apparatus. The configuration of the network learning apparatus may include, for example, configuring the worker computers 102, the assignment computer connections, the analysis computer 140, or a combination thereof, to communicate an item of information, for example, a nonce, extranonce, or both, a difficulty level of a condition, a number of bits of the set of elements to be tested, etc. The configuration of the network learning apparatus may include, for example, configuring the worker computers 102, the assignment computer connections, the analysis computer 140, or a combination thereof, configuring the operation of a computer, for example, to relay instructions 114, relay responses 136, act as a proxy server, to test elements 120 of the set 118 to determine whether any said element 122 of the set 118 satisfied the condition 124 by performing cryptographic hashes, to perform cryptographic hash algorithms such as SHA-256, SHA-512 SHA-3, or Keccak, or to mine one or more cryptocurrencies including of Bitcoin, Ethereum, Bitcoin Lite, XRP, Cardano, Tether, Polkadot, Stellar, and USD Coin. The configuration of the network learning apparatus may include, for example, configuring the worker computers 102, the assignment computer connections, the analysis computer 140, or a combination thereof, configuring the operation of a computer such that the condition that determines whether one said condition that is satisfied is implemented by a computer program communicated over the assignment computer connection from which the instruction was received. Other methods of configuring of the network learning apparatus may be devised and preferred in one application or another.

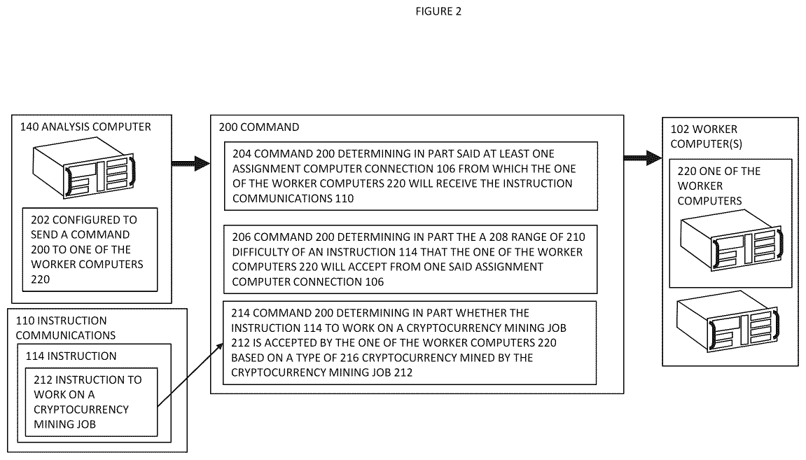

FIG. 2 illustrates a flow of a network architecture. An analysis computer 140 may be configured to send a command 200 to one 220 of the worker computers 102. A command 200 may alter the behavior of the of the one worker computers 220. An analysis computer 140 may be configured to send a command 200 to one 220 of the worker computers 102 that may determine 204 in part said at least one assignment computer connection 106 from which the one of the worker computers 220 will receive the instruction communications 110. For example, the analysis computer 140 may determine that the instructions 114 received by worker computers 102 from a particular assignment computer connection 106 are more likely to satisfy a condition 124. The analysis computer 140 could then send a command 200 to one of the worker computers 220 to receive instructions 114 from the particular assignment computer connection 106. The one of the worker computers 220 would then receive an instruction 114 from the assignment computer connection 106.

An analysis computer 140 may be configured to send a command 200 may determine in part a range 208 of difficulty 210 of an instruction 114 that the one of the worker computers 220 will accept from one said assignment computer connection 106. For example, there may be a reward for finding an element 122 of the set 118 that satisfies a condition 124. The condition 124 may have a difficulty 210, with elements 122 that satisfy a condition 124 with a greater difficulty 210 requiring more computational effort to find, and elements 122 that satisfy a condition 124 with a lesser difficulty 210 requiring less computational effort to find. The reward may be greater to find elements 122 that satisfy a condition 144 with a greater difficulty 210, however, if an element 122 is not found that satisfies the condition 144, no reward is obtained. An analysis computer 140 may determine that a particular level of difficulty 210 may obtain the greatest overall reward. The analysis computer may then send a command 200 to one of the worker computers 220 specifying a range 208 of difficulty 210 that the one of the worker computers 220 will accept from one said assignment computer connection 106. In response, the one of the worker computers 220 may only accept or preferentially accept the instructions 114 with a difficulty 210 within the specified range 208 of the command 200.

An instruction 114 may be an instruction 212 to work on a cryptocurrency mining job. An analysis computer 140 may be configured to send a command 200 to determine in part whether the instruction 114 to work on a cryptocurrency mining job 212 is accepted by the one of the worker computers 220 based on a type 216 of cryptocurrency mined by the cryptocurrency mining job 212. An assignment computer connection 106 may be a connection between the one of the worker computers 220 and a cryptocurrency mining pool, for example using the Stratum protocol. An instruction 114 from a cryptocurrency mining pool may be to mine cryptocurrency. An instruction 114 to mine cryptocurrency can include testing inputs to a cryptographic hash function to see if the output of the hash function satisfies a criterion 124. The inputs to the cryptographic hash function to be tested by the one of the worker computers 220 may be included in the specification 116 of the set 118 of elements 120 to be tested, with each possible input to be tested being an element 120 of the set 118. The one of the worker computers 220 may connect to one or more assignment computer connections 106 that send the one of the worker computers 220 an instruction 114 to mine cryptocurrency. A cryptocurrency of an instruction 114 to mine cryptocurrency received by the one of the worker computers 220 may be one of different types 216 of cryptocurrencies. For example, the type 216 of cryptocurrency to be mined by the one of the worker computers 220 when an instruction 114 to mine cryptocurrency is received may depend on which assignment computer connection 106 sent the instruction 114. As an example, Bitcoin, Bitcoin Cash, and Bitcoin SV are types 216 of cryptocurrency that a SHA-256 cryptocurrency miner worker computer could mine cryptocurrency for. An analysis computer 140 may determine that it is more profitable to mine a particular type 216 type of cryptocurrency. The analysis computer 140 may then send a command to the one of the worker computers 220 that determines in part whether the instruction 114 to work on a cryptocurrency mining job 212 is accepted by the one of the worker computers 220 based on a type 216 of cryptocurrency mined by the cryptocurrency mining job 212, with the type 216 of cryptocurrency being the more profitable cryptocurrency. To preferentially receive instructions 114 to mine the particular type 216 of cryptocurrency as given in the command 200, the one of the worker computers 220 may then connect to an assignment computer connection 106 that sends instructions 114 to mine that particular type 216 of cryptocurrency.

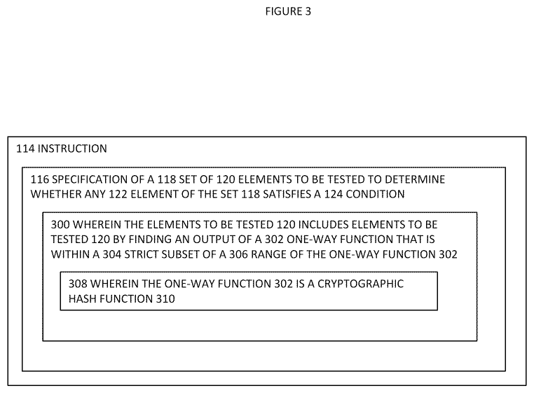

FIG. 3 is an embodiment of an instruction. The instruction includes a 116 specification of a set 118 of elements 120 to be tested to determine whether any element 122 of the set 118 satisfies a condition 124. The elements to be tested 300 may include elements to be tested 120 by finding an output of a one-way function 302 that is within a strict subset 304 of a range 306 of the one-way function 302. The range of a function indicates the set for which the elements of that set are all of the possible values of the output of a function. A strict subset of the range of a function indicates a set that may contain only elements present in the range of the function but must exclude at least one element of the range of the function. A one-way function is a function for which, given a target output or set of outputs of the one-way function, no method of finding an input to the function that produces a target output finds the answer with significantly less effort than a method that exhaustively tests inputs to the one-way function. A one-way function 302 may be a cryptographic hash function 310 308. An instruction 114 may specify 116 that the condition is satisfied 124 by finding an output of a one-way function 302 that is within a strict subset 304 of a range 306 of a one-way function 302. An example of this is an instruction 114 that specifies 116 that the condition to be satisfied 124 is that an element 120 is to be transformed by a cryptographic hash function 310 and that the output of the cryptographic hash function 310 satisfies the condition 124 that the output is less than a specified target number.

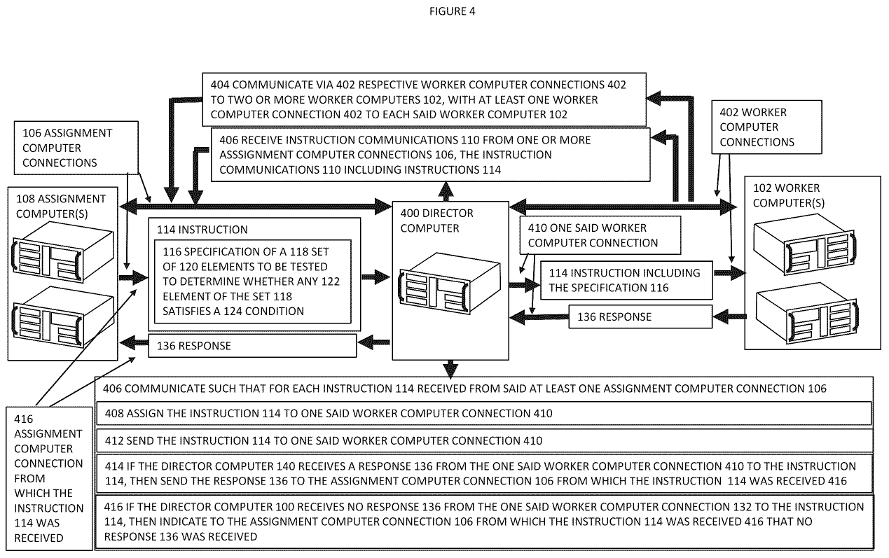

FIG. 4 is an illustration of an embodiment of flow of a network architecture. An embodiment may have a director computer 400. The director computer 400 may receive 406 instruction communications 110 from one or more assignment computer connections 106, the instruction communications 110 including instructions 114. An instruction 114 may include a specification of a set 118 of elements 120 to be tested to determine whether any element 112 of the set 118 satisfies a condition 124. These instructions 114 may be the same instructions that would be communicated via an assignment computer connection 106 to a worker computer 102 if the worker computer 102 is connected to an assignment computer connection 106. The director computer 400 may communicate via respective worker computers connections 402 to two or more worker computers 102, with at least one worker computer connection 402 to each said worker computer 102. In some cases, rather than have the worker computers 102 receive instructions 114 from assignment computer connections 106, it may be more desirable to have a director computer 400 receive instructions 114 from the assignment computer connections 106. The director computer 400 may then pass instructions 114 from the assignment computer connections 106 to the worker computers 102, and pass the responses 136 to the instructions 114 from the worker computers 102 to the assignment computer connections 106, and the passing of the instructions 114 and responses 136 may be operated in accordance with commands that may be received from the analysis computer 140. The analysis computer 140 then may send commands to the director computer 400, rather than to one or more worker computers 102, to effect changes in the operation of the network, e.g., to minimize the changes in configuration required to worker computers 102 to change their behavior. In some cases, changing the behavior of a director computer 400 may be more easily achieved than changing the behavior of worker computers 102.

The director computer 400 may communicate 406 such that for each instruction 114 received from said at least one assignment computer connection 106: the director computer 400 assigns 408 the instruction 114 to one said worker computer connection 410; the director computer 400 sends 412 the instruction 114 to one said worker computer connection 410; if the director computer 400 receives a response 136 from the one said worker computer connection 410 to the instruction 114, then send the response 136 to the assignment computer connection 106 from which the instruction 114 was received 416, and if the director computer 400 receives no response 136 from the one said worker computer connection 410 to the instruction 114, then indicate to the assignment computer connection 106 from which the instruction 114 was received 416 that no response 136 was received. The director may receive an instruction 114 from an assignment computer connection 106. The director computer may or may not, in accordance with commands it has received from the analysis computer 140 and/or a predetermined rule, assign 408 the instruction 114 to one said worker computer connection 410. The one said worker computer connection 410 that the instruction 114 is assigned to may be selected by the director computer 400 using many methods. Worker computers 102 that communicate to the director computer 400 through respective worker computer connections 402 may have different capabilities, for example, some may be able to perform particular instructions 114, and so the director computer 400 may assign an instruction 114 to a worker computer connection 402 so that a worker computer 102 that is capable of performing the instruction 114 receives the instruction 114. The capability of a worker computer 102 may be determined in part by the presence of a particular central processing unit, a particular amount of random-access memory, a particular amount of nonvolatile storage, specialized hardware such as FPGAS, GPGPUs, TPUs, hardware to perform cryptographic operations such as hashes, etc. A worker computer 102 may have its computational capacity currently committed and therefore be unable to accept new instructions 114 unless the worker computer completes an instruction 114 or otherwise has its computational capacity uncommitted. A director computer 400 may assign an instruction 114 to a worker computer connection 402 so that a worker computer 102 with currently available computational capacity receives the instruction 114. A director computer 400 may assign an instruction 114 to a worker computer connection 402 that is randomly selected or in accordance with a predetermined rule.

A director computer 400 may send to the one said worker computer connection 410 an instruction 114 assigned to the one said worker computer connection 410. The director computer may then receive a response 136 to the instruction 114 from the one said worker computer connection 410 to which the director computer 400 sent the instruction 114. The director computer 400 may send the response 136 to the assignment computer connection 106 from which the instruction 114 was received 416 in accordance with commands it has received from the analysis computer 140 and/or a predetermined rule. The director computer 400 may not receive a response 136 to the instruction 114 from the one said worker computer connection 410 to which the director computer 400 sent the instruction 114. The director computer 400 may then indicate to the assignment computer connection 106 that no response 136 was received, for example, by sending a response to the assignment computer connection 106 to the instruction 114 indicating that no response 136 was received from the worker computer connection 410. The director computer 400 may or may not indicate to the assignment computer connection 106 that no response 136 was received in accordance with commands it has received from the analysis computer 140 and/or a predetermined rule.

A director computer 400 may be commodity computer hardware, for example based on processors from Intel, AMD, ARM-based, RISC-V based, etc. It is typically equipped with random access memory such as DRAM, nonvolatile storage such as rotating magnetic media or NAND flash storage, and one or more network connections such as Ethernet, wireless networks such as WiFi and mobile telephone networks, to a local area network (LAN), to a wide area network (WAN), etc. A director computer 400 may be equipped with connections to one or more networks, a network including the assignment computer connections 106 and a network including the worker computer connections 102. A director computer 400 may include an operating system such as Windows, Linux, MacOSX, a variant of BSD, etc. A director computer may include software to effect the communication of instructions 114 and responses 136, and/or the communication of commands 500 which may be implemented in computer languages such as C, C++, Python, Java, Rust, Golang, etc.

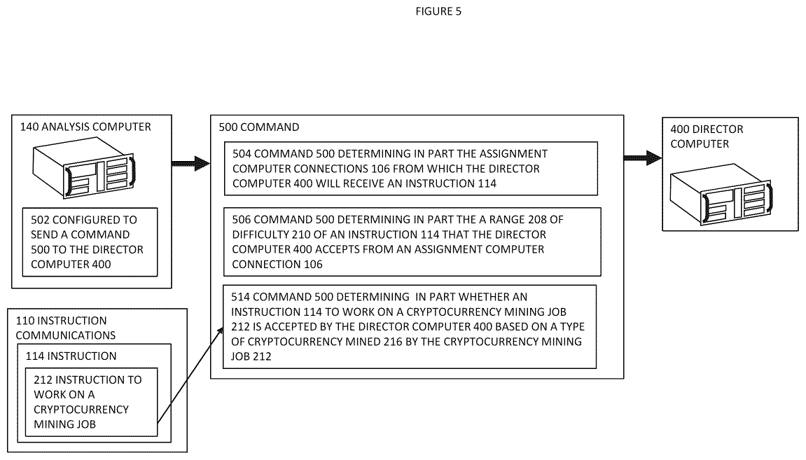

FIG. 5 is an illustration of an embodiment of flow of the network architecture. An analysis computer 140 may be configured 502 to send a command 500 to the director computer 400. A command 500 may alter the behavior of the of the director computer 400. The analysis computer 140 may be configured to send 504 a command 500 to the director computer 400 determining in part the assignment computer connections 106 from which the director computer 400 will receive an instruction 114. The analysis computer 140 may be configured to send 506 a command 500 to the director computer 400 determining in part a range 208 of difficulty of an instruction 114 that the director 400 accepts from an assignment computer connection 106. The analysis computer 140 may be configured to send 514 a command 500 determining in part whether an instruction 114 to work on a cryptocurrency mining job 212 is accepted by the director computer 400 based on a type of cryptocurrency mined 216 by the cryptocurrency mining job 212. These commands 500 may be sent to the director computer 400 rather than worker computers 102 so that the director computer 400 can implement the changes in behavior and policies as commanded by the analysis computer 140 by mediating the connections, instructions 114, and responses 136 between the assignment computer connections 106 and the worker computers 102. This enables the changes in behavior and policies to be more centrally implemented on a director computer 400 rather than on individual worker computers 102.

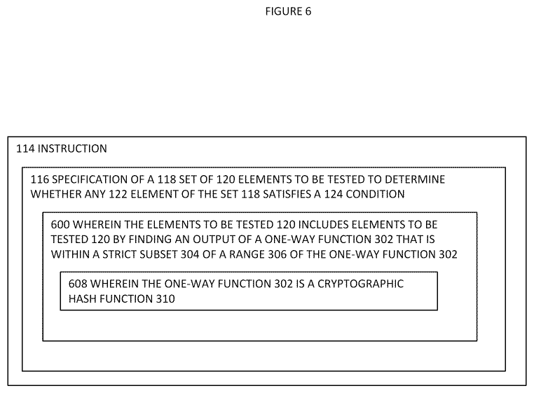

FIG. 6 is an embodiment of an instruction. The instruction includes a 116 specification of a set 118 of elements 120 to be tested to determine whether any element 122 of the set 118 satisfies a condition 124. The elements to be tested 600 may include elements to be tested 120 by finding an output of a one-way function 302 that is within a strict subset 304 of a range 306 of the one-way function 302. A one-way function 302 may be a cryptographic hash function 310 608. The instructions 114 received by the director computer 400 from the assignment computer connections 106 may be the same as those as would be received by a worker computer 102 from an assignment computer connection 106, and therefore the same specifications 116, sets 118, elements 120, and conditions 124 may be present in an instruction 114 sent to a director computer 400 and sent to a worker computer 102.

The computers in the network may be organized to direct computing effort according to the machine learning model 148 after the machine learning model 148 is adjusted 156 toward the criterion 152 to the optimality 154. An analysis computer 140 records may create training data 146 based on instruction communications 110 and response communications 112. The training data 146 may include information useful for determining how the computing effort of computers on the network should be organized. For example, which elements 122 better satisfy a condition 124 may be inferred from the amount of time elapsed between an instruction 114 and the response 136 to the instruction 114, or whether or not there is a response 136 to an instruction 114. One may be able to infer based on the specifications 116 of the elements 120 to be tested which subsets of the possible solutions are being tested on the network. A network machine learning model 148 may then be adjusted 156 toward the criterion 152 to the optimality 154 based on the training data 146. The analysis computer 140 may be configured to send commands to direct the computing effort of the network according to the machine learning model 148. For example, if the machine learning model 148 identifies elements 122 of the set that may better satisfy the condition 124, the analysis computer 140 may send commands to direct the computing effort to these identified elements 122. As another example, if the machine learning model 148 is trained with training data 146 formed from instructions 114 and responses 136 to perform cryptocurrency mining, the machine learning model 148 may identify particular assignment computer connections 106 or particular cryptocurrencies for which if the worker computers 102 perform instructions 114, the worker computers 102 may be more likely to find 122 elements of the 118 that satisfy a condition 124, which may result in a successful mining of cryptocurrency. The analysis computer 140 may send commands to direct the computing to performing instructions 114 for the identified assignment computer connections 106 or identified cryptocurrencies. In doing so, a network machine learning model 148 that has been adjusted toward the criterion 152 for the optimality 154 may be used to direct computing effort.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. A network learning apparatus, the apparatus comprising:
worker computers, each of the worker computers configured to:
receive instruction communications from at least one assignment computer connection, the instruction communications including an instruction that specifies a set of elements to be tested to determine whether any element of the set satisfies a condition;
determine whether any of the elements of the set of elements specified in the instruction satisfies the condition; and
send at least one response communication to said at least one assignment computer connection from which the instruction was received indicating which, if any, elements of the set of elements satisfies the condition; and
an analysis computer, communicatively connected to the worker computers, configured to:
record at least a portion of the instruction communications and at least a portion of said at least one response communication to produce training data;
create, from said at least a portion of the instruction communications and said at least a portion of said at least one response communication, a network machine learning model that includes at least one parameter and a criterion for optimality; and
adjust said at least one parameter of the machine learning model toward the criterion to optimality based on the training data.

2. The apparatus of claim 1, wherein the analysis computer is further configured to send a command to one of the worker computers, the command determining in part said at least one assignment computer connection from which the one of the worker computers will receive the instruction communications.

3. The apparatus of claim 1, wherein the analysis computer is further configured to send a command to one of the worker computers, the command determining in part a range of difficulty of the instruction that the one of the worker computers will accept from one said assignment computer connection.

4. The apparatus of claim 1, wherein the elements to be tested includes elements to be tested by finding an output of a one-way function that is within a strict subset of a range of the one-way function.

5. The apparatus of claim 4, wherein the one-way function is a cryptographic hash function.

6. The apparatus of claim 1, wherein the instruction includes at least one instruction to work on a cryptocurrency mining job.

7. The apparatus of claim 6, wherein the analysis computer is further configured to send a command to the one of the worker computers, the command determining in part whether the instruction to work on the cryptocurrency mining job is accepted by the one of the worker computers based on a type of cryptocurrency mined by the cryptocurrency mining job.

8. The apparatus of claim 1, further including a director computer configured to:
communicate via respective worker computer connections to two or more worker computers, with at least one worker computer connection to each said worker computer;
for each of the worker computers:
receive the instruction communications from said at least one assignment computer connection, the instruction communications including an instruction that specifies a set of elements to be tested to determine whether any element of a set satisfies the condition;
communicate such that for each said instruction received from said at least one assignment computer connection:
assign the instruction to one said worker computer connection;
send the instruction to the one said worker computer connection; and
if a response is received from the one said worker computer connection to the instruction, then send the response to said at least one assignment computer connection from which the instruction was received,
if no response is received from the one said worker computer connection to the instruction, then indicate to said at least one assignment computer connection from which the instruction was received that no response was received.

9. The apparatus of claim 8, wherein the analysis computer is further configured to send a command to the director computer, the command determining in part the assignment computer connection from which the director computer will receive an instruction.

10. The apparatus of claim 8, wherein the analysis computer is further configured to send a command to the director computer, the command determining in part a range of difficulty of instructions that the director computer will accept from said at least one assignment computer connection.

11. The apparatus of claim 8, wherein the elements to be tested includes elements to be tested by finding output of a one-way function that is within a strict subset of a range of the one-way function.

12. The apparatus of claim 11, wherein the one-way function is a cryptographic hash function.

13. The apparatus of claim 8, wherein each said instruction is an instruction to work on a cryptocurrency mining job.

14. The apparatus of claim 13, wherein the analysis computer is further configured to send a command to the director computer, the command determining in part if an instruction to work on the cryptocurrency mining job is accepted by the director computer based on a type of cryptocurrency mined by the cryptocurrency mining job.

15. The apparatus of claim 1, further including a network comprising the computers organized to direct computing effort according to the machine learning model after being adjusted toward the criterion to the optimality.

16. The apparatus of claim 8, wherein the director computer authenticates the response sent to the assignment computer connection from which the instruction was received that includes identification of an element of the set that satisfies the condition.

17. The apparatus of claim 8, wherein the director computer encrypts the response sent to the assignment computer connection from which the instruction was received that includes identification of an element of the set that satisfies the condition.

18. The apparatus of claim 8, wherein the director computer verifies a signature on the response sent to the assignment computer connection from which the instruction was received that includes identification of an element of the set that satisfies the condition.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. A process of making a network learning apparatus, the process comprising:
configuring a network learning apparatus, the configuring including:
interconnecting worker computers and at least one assignment computer connection;
configuring each of the worker computers to:
receive instruction communications from said at least one assignment computer connection, the instruction communications including an instruction that specifies a set of elements to be tested to determine whether any element of the set satisfies a condition;
determine whether any of the elements of the set of elements specified in the instruction satisfies the condition; and
send at least one response communication to said at least one assignment computer connection from which the instruction was received indicating which, if any, elements of the set of elements satisfies the condition; and
configuring an analysis computer to communicatively cooperate with the worker computers to:
record at least a portion of the instruction communications and at least a portion of said at least one response communication to produce training data;
create, from said at least a portion of the instruction communications and said at least a portion of said at least one response communication, a network machine learning model that includes at least one parameter and a criterion for optimality; and
adjust said at least one parameter of the machine learning model toward the criterion to optimality based on the training data.

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. A process comprising:
communicating, by each of a plurality of worker computers, including:
receiving instruction communications from at least one assignment computer connection, the instruction communications including an instruction that specifies a set of elements to be tested to determine whether any element of the set satisfies a condition;
determining whether any of the elements of the set of elements specified in the instruction satisfies the condition; and
sending at least one response communication to said at least one assignment computer connection from which the instruction was received indicating which, if any, elements of the set of elements satisfies the condition; and
communicating, by an analysis computer, communicatively cooperating with said worker computers and said at least one assignment computer, including:
recording at least a portion of the instruction communications and at least a portion of said at least one response communication to produce training data;
creating, from said at least a portion of the instruction communications and said at least a portion of said at least one response communication, a network machine learning model that includes at least one parameter and a criterion for optimality; and
adjusting said at least one parameter of the machine learning model toward the criterion to optimality based on the training data.

161. (canceled)

162. (canceled)

163. (canceled)

164. (canceled)

165. (canceled)

166. (canceled)

167. (canceled)

168. (canceled)

169. (canceled)

170. (canceled)

171. (canceled)

172. (canceled)

173. (canceled)

174. (canceled)

175. (canceled)

176. (canceled)

177. (canceled)

178. (canceled)

179. (canceled)

180. (canceled)

181. (canceled)

182. (canceled)

183. (canceled)

184. (canceled)

185. (canceled)

186. (canceled)

187. (canceled)

188. (canceled)

189. (canceled)

190. (canceled)

191. (canceled)

192. (canceled)

193. (canceled)

194. (canceled)

195. (canceled)

196. (canceled)

197. (canceled)

198. (canceled)

199. (canceled)

200. (canceled)

201. (canceled)

202. (canceled)

203. (canceled)

204. (canceled)

205. (canceled)

206. (canceled)

207. (canceled)

208. (canceled)

209. (canceled)

210. (canceled)

211. (canceled)

212. (canceled)

213. (canceled)

214. (canceled)

215. (canceled)

216. (canceled)

217. (canceled)

218. (canceled)

219. (canceled)

220. (canceled)

221. (canceled)

222. (canceled)

223. (canceled)

224. (canceled)

225. (canceled)

226. (canceled)

227. (canceled)

228. (canceled)

229. (canceled)

230. (canceled)

231. (canceled)

232. (canceled)

233. (canceled)

234. (canceled)
